(19) United States
(12) Patent Application Publication
(10) Pub. No.: US 2008/0027362 A1
(43) Pub. Date: Jan. 31, 2008

(54) Prostate massager and libido stimulating device

(76) Inventor: Gerald Fretz, Fort Lauderdale, FL (US)

Correspondence Address: WILSON DANIEL SWAYZE, JR., 3804 CLEARWATER CT., PLANO, TX, 75025, US

(21) Appl. No.: 11/493,162

(22) Filed: Jul. 26, 2006

(51) Int. Cl. A61H 1/00

(52) U.S. Cl. 601/46

(57) ABSTRACT

An apparatus for massaging a prostate gland by contraction of a sphincter includes a head which includes an angled head portion having an electrical vibrator. The head has a size suitable for fitting into a human rectum and through the sphincter. The head has an angled head portion and a cylinder portion which is connected to a tapered portion. The tapered section narrows in diameter from the head portion. The tapered portion is connected to a body which in turn is connected to a C shaped portion in the inward extending portion. The body extends traverse with respect to the tapered portion so that the tapered portion remains movably held within the sphincter.

### TECHNICAL FIELD

The present invention relates to apparatus for the treatment of prostatitis. More particularly, the present invention relates to devices for massaging the prostate gland.

### BACKGROUND ART

One treatment for non-bacterial disorder of prostate such as chronic prostatitis and a congested prostate is the prostate massage. Some urologists believe that the most effective treatment for such prostatitis is for the doctor to massage the prostate at regular intervals. Other urologists are far less enthusiastic about this procedure, and some do not believe in it at all. To perform such a massage, the physician simply inserts a gloved finger into the rectum and strokes the prostate very gently. It serves to relieve the symptoms of chronic prostatitis by draining accumulated prostatic fluid from the glands and ducts.

Given the difference of opinion of urologists as to the need for prostatic massages, such massages can be difficult to obtain. In any event, the regular and repeated massaging of the prostate can often require frequent visits to the doctor's office. This causes the patient to incur a considerable expense and inconvenience. As such, a need has developed for allowing an individual to carry out his own prostatic massage.

In the past, some patents have issued relating to rectal devices. U.S. Pat. No. 4,542,753, issued on Sep. 24, 1985 to Brenman et al. describes an apparatus and method for stimulating penile erectile tissue. In this invention, a body is provided which may be inserted into the rectum of a user. The body is shaped so as to closely conform to the topological configuration of the rectum within the anal area to a site adjacent to the prostate gland. Electrical circuitry for generating a neurally stimulating electrical signal is located within the body. Electrodes, placed at particular locations on the surface of the body, apply the signal to the user. At least one of the electrodes closely contacts the prostate gland when the body member is operatively disposed, at a region or spot on the prostate gland previously determined to be sensitive to electrical stimulation.

U.S. Pat. No. 5,404,881, issued on Apr. 11, 1995, to Cathaud et al. describes a trans-rectal probe. This trans-rectal probe includes a probe body made of a flexible self-supporting polymer material whose degree of flexibility is designed to enable it to comply with the shape of the rectum while having substantially no compression effect on the rectum when inserted therein. The invention makes it possible to achieve accurate, safe and reliable positioning or an instrument for detection or therapeutic treatment level with the organ to be observed or treated. In particular, this device is designed for treatment of the prostate.

U.S. Pat. No. 2,478,786, issued on Aug. 9, 1949 to H. M. Smallen, describes a prostate gland massaging implement. This implement includes a lever having an interior handle which constitutes a power arm to extend down in front of the abdomen and a substantially horizontal portion extending under the groin and offset laterally to avoid the genital organs. The implement has an upwardly and forwardly bent posterior portion which forms the work arm. This work arm extends into the rectal passage to bear across the frontal wall thereon adjacent the prostate gland. The bent portion between the horizontal and the posterior portions serves as a fulcrum point against the front wall of the rectal opening when the implement is subject to pivotal movement around this point

The U.S. Pat. No. 5,797,950 to Takashima, issued on Aug. 5, 1998, describes a device including a head having a size suitable for fitting in a human rectum and through a sphincter. The head has a size suitable for rubbing the prostate gland. A rod is connected to the bottom of the head and extends outwardly there from. The rod serves to position the head and guide a movement of the head as the sphincter contracts and relaxes. An abutment surface is affixed to the rod distal the head. The abutment surface contacts the perineum area and pushes up on the perineum area as the sphincter contracts. The rod is a rigid rod having a generally L-shaped or C-shaped configuration with a radius of curvature such that the head tilts toward the prostate gland as the sphincter contracts and draws the head upwardly. The head has a generally ellipsoidal shape.

U.S. Pat. No. 5,861,009 to the Takashima, describes an apparatus for releasing congested prostate fluid having a head with a size suitable for fitting into a human rectum and through the sphincter and having a surface for pushing on the prostate gland. A rod is connected to the bottom of the head and extends outwardly there from so as to guide a movement of the head as the sphincter relaxes and contracts. An abutment member is positioned on the rod opposite the head so as to push on the perineum area simultaneously with the head pushing on the prostate gland. The abutment member has a variable angular relationship with the head.

U.S. Pat. 6,802,850 to Takashima discloses another similar device.

### OBJECTS OF THE INVENTION

It is an object of the present invention to provide an apparatus which enables persons to carry out self-massages of the prostate so as to remove the excess the fluid from the congested prostate.

It is another object of the present invention to provide a prostate massage apparatus which increases the amount of pressure applied to the perineum area.

It is a further object of the present invention to provide a prostate massage apparatus which facilitates the ability of the users to control the position of the head of the prostate massage apparatus within the rectum through the application of rectal pressure and sphincter contraction.

It is a further object of the present invention to provide such a prostate massage apparatus which is safe, easy to use and relatively inexpensive.

It is a further object of the present invention to provide a prostate massage apparatus which includes an electrical vibrator.

It is a further object of the present invention to provide a prostate massage apparatus which includes an electrical vibrator which is controllable by the user.

These and other objects and advantages of the present invention will become apparent from a reading of the attached specification and appended claims.

### SUMMARY OF THE INVENTION

The present invention is an apparatus for massaging a prostate gland by a contraction of a sphincter comprising a head and a tapered portion. The head has a size suitable for fitting into a human rectum and through the sphincter. The head has an angled head portion and a cylinder portion. The tapered section narrows in diameter from the angled head portion and the cylinder portion. An inward extending portion is positioned on the distal end of a body so as to push on the perineum area simultaneously with the angled head portion pushing on the prostate gland. The tapered portion is adapted to movably hold the tapered section of the head within the sphincter.

In the present invention, the tapered portion, the angle head portion and the cylindrical portion a total length greater than a length of the sphincter.

The present invention includes an electrical vibrator which is positioned within the angled head portion so that the prostate can be stimulated by the vibration from the electrical vibrator. Additionally, the electrical vibrator can be controlled by a control device to control the speed of the vibration of the electrical vibrator.

### BRIEF DESCRIPTION OF THE DRAWINGS

The invention may be understood by reference to the following description taken in conjunction with the accompanying drawings, in which, like reference numerals identify like elements, and in which:

FIG. 1 is a cross-sectional view of the prostate massage of the present invention.

FIG. 2 is a cross-sectional view showing the actual application of the device within a human rectum.

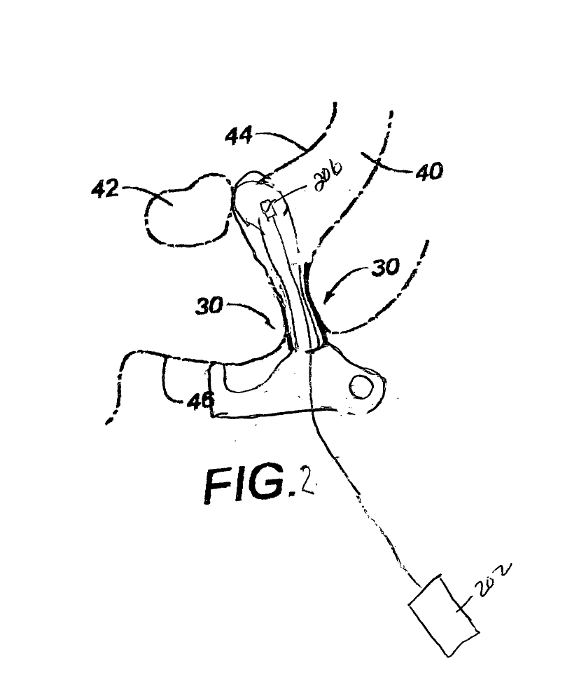

### DETAILED DESCRIPTION OF THE INVENTION

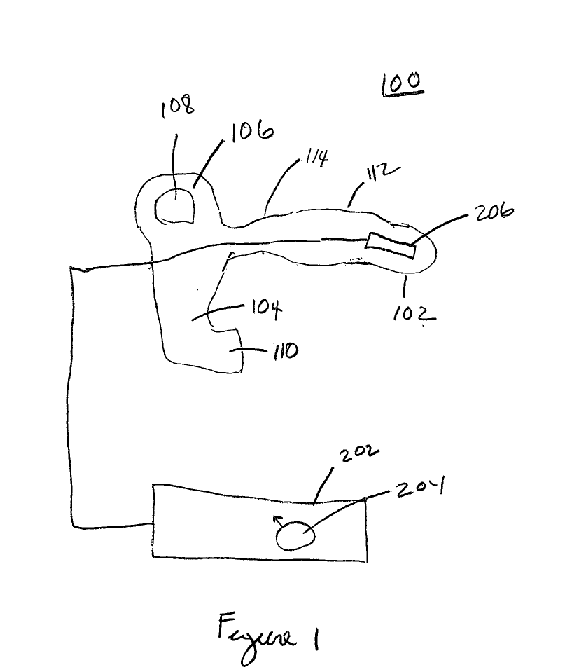

Referring to FIG. 1, there is shown at 100 the prostate massage apparatus in accordance with the preferred embodiment of the present invention. The prostate massage apparatus 100 includes an angled head portion 102, a cylindrical portion 112, a tapered portion 114, a body 104, a C shaped portion 106 having an hole 108 and an inward extending portion 110. The prostate massage apparatus 100 additionally includes a control device 202 to control by turning on and off and by regulating the speed of the electrical vibrator 206. The body 104 includes, at the proximate end, the C shaped portion 106 having the hole 108 to provide a handle for the prostate massage apparatus 100 so that the prostate massage apparatus 100 can be easily removed by the user. The body 104 additionally includes an inward extending portion 110 at the distal end of the body 104 so as to push on the perineum area 46 simultaneously with the angled head portion 102 pushing on the prostate gland 42. The angle that the angled head portion 102 makes with respect to the cylindrical portion 112 is sufficient so that the inward extending portion 110 contacts the perineum area 46 and the angle head portion 102 is positioned to contact the prostate 42 through the wall 44 of the rectum 40. The angled head portion 102 is connected to the cylindrical portion 112 which is in turn connected to the tapered portion 114. The tapered portion 114 is connected to the body 104 at approximately 90° from the longitudinal direction of the body 104. At one end of the longitudinal body 104 is positioned the C shaped portion 106, and that another end of the longitudinal body 104 is positioned the inward extending portion 110 which is substantially parallel to the cylindrical portion 112 and the tapered portion 114. The electrical vibrator 206 is positioned within the angled head portion 102 to provide vibration to the prostate 42. The stimulation of the prostate 42 by the electrical vibrator 206 avoids the need for the user to provide the stimulation of the prostate 42. Furthermore, the amount of stimulation of the prostate 42 can be controlled and can be varied by the control device 220. Typically, the prostate massage apparatus 100 is formed from solid flexible material.

The prostate massage apparatus 100 is inserted into the rectum of the user, and because of the cross-sectional size of the angled head portion 102, the sphincter 30 expands to accept the angled head portion 102 and subsequently expands to accept the cylindrical portion 112. Next, the tapered portion 114 enters the sphincter 30 and consequently because of the reduced diameter of the tapered portion 114, the sphincter 30 contracts. When the sphincter 30 contracts, the lateral pressure applied to the tapered portion 114 pushes the angled head portion 102 upwardly while the inward extending portion 110 simultaneously applies a pressure to the perineum area 46.

The angled head portion 102 has a sufficient diameter so as to hold the angled head portion 102 within the rectum against the rectal pressure when the sphincter relaxes. The total length of the tapered portion 114 may be greater than the length of the sphincter.

FIG. 4 illustrates the prostate massage apparatus 100 as located within the rectum 40. In FIG. 4, it can be seen that the angled head portion 102 has been inserted into the rectum 24 through the sphincter 30. The angled head portion 102 is positioned by the inward extending portion 110 in proximity to the prostate 42. The prostate 42 is rubbed through the wall 44 of the rectum 40 by virtue of the electrical vibrator 206 vibrating and being controlled by the control device 202. The angled head portion 102 is designed so as to reside in close proximity to the prostate 42 when the angled head portion 102 is inserted through the sphincter 30. The inward extending portion 110 extends inwards by virtue of the body 104 and is positioned adjacent to the perineum area 46. The inward extending portion 110 can be configured so as to apply pressure to the perineum area 46 at the same time that the angled head portion 102 is massaging the prostate 42. As such, the prostate massage apparatus 100 massages the prostate 42 and also provides stimulation to the perineum area 46.

The foregoing disclosure and description of the invention is illustrative and explanatory thereof. Various changes in the details of the illustrated construction may be made within the scope of the appended claims without departing from the true spirit of the invention.

I claim:

1. An apparatus for massaging a prostate gland by a contraction of a sphincter, comprising:
an angled head portion and a cylinder portion, the angled head portion being angled with respect to said cylinder portion, said angle head portion having a size suitable for fitting into a human rectum and through the sphincter,
a tapered portion extending from said cylinder portion, said tapered section narrowing in diameter from said cylinder portion, said tapered portion being movably retained within said sphincter,
an electrical vibrator for providing vibrations to said prostate,
a control circuit for controlling said electrical vibrator.

2. An apparatus for massaging a prostate gland by a contraction of a sphincter as in claim 1, wherein said apparatus includes a inward extending portion to stimulate a perineum area.

3. An apparatus for massaging a prostate gland by a contraction of a sphincter as in claim 2, wherein said inward extending portion is adjacent to said perineum area wherein said angle head portion is adjacent to said prostate.

4. An apparatus for massaging a prostate gland by a contraction of a sphincter as in claim 1, wherein said control circuit controls the speed of said electrical vibrator.

5. An apparatus for massaging a prostate gland by a contraction of a sphincter as in claim 1, wherein said electrical vibrator is positioned within said angled head portion.
